(19) United States
(12) Patent Application Publication
(10) Pub. No.: US 2026/0126078 A1
(43) Pub. Date: May 7, 2026

(54) SUSPENSION THRUST BEARING UNIT

(71) Applicant: AKTIEBOLAGET SKF, GOTEBORG (SE)

(72) Inventors: Bruno MONTBOEUF, Saint-Cyr-Sur-Loire (FR); Jonathan REPESSE, Esvres sur Indre (FR); Jordan RENAUDON, Saint Cyr sur Loire (FR)

(21) Appl. No.: 19/371,178

(22) Filed: Oct. 28, 2025

(30) Foreign Application Priority Data
Nov. 7, 2024 (DE) 102024210741.7

(51) Int. Cl. F16C 19/10; F16C 33/80

(52) U.S. Cl. CPC F16C 19/10; F16C 33/80; F16C 2326/05

(57) ABSTRACT

A suspension thrust bearing unit includes upper and lower annular caps and a rolling-element bearing therebetween. The lower annular cap includes an annular circumferential groove between first and second radially outwardly extending seal flanges, and the upper annular cap includes an outer axial skirt that extends axially from the upper cap towards the lower cap and radially surrounds the second seal flange. The first and second seal flanges and the axial skirt form a labyrinth seal. The groove includes a plurality of circumferentially spaced ribs each extending radially outward from the lower cap and axially from the first seal flange to the second seal flange, and the plurality of ribs are at least partially located inside the outer axial skirt.

### CROSS-REFERENCE

This application claims priority to German patent application no. 102024 210 741.7 filed on DATE, the contents of which are fully incorporated herein by reference.

### TECHNOLOGICAL FIELD

The present disclosure concerns the field of suspension thrust bearing units, in particular of the MacPherson type. Such suspension thrust bearing units form part of a suspension assembly for use in a motor vehicle.

### BACKGROUND

As a general rule, a motor vehicle suspension system comprises a suspension assembly supporting an axle and a vehicle wheel. A suspension thrust bearing unit is disposed in an upper portion of the suspension assembly, opposite to the wheel and the ground, and between a suspension spring and an upper support block attached to the body of the vehicle. The suspension thrust bearing unit includes at least one rolling bearing.

The suspension thrust bearing unit enables the transmission of axial forces between the spring and the body of the vehicle and, in the meantime, allows relative angular movement between the spring, which is mobile in rotation, and the fixed support block attached to the body. To this end, the spring is supported by a spring seat provided on the suspension thrust bearing unit. More precisely, the suspension thrust bearing comprises a lower support surface resting on ending coils of the spring. The spring support surface comprises a radially extending surface configured to support an axial force. The spring support surface may also comprise a tubular axial surface to oppose radial deformations and to ensure the spring centering.

Suspension thrust bearing unit is used in environments subject to constant pollution, in particular dust, particles, water. EP 1 000 781, US 6,186,507 and WO 07/037308 are examples of patent publications that disclose suspension thrust bearing units provided with sealing means so as to prevent entry of pollution within the units. The sealing means comprising contacting lips. However, such sealing means are not fully satisfactory because they create friction between the two parts of units in relative rotation.

It is also known from WO 2010/063305 or JP 2006-322505 to provide a labyrinth seal without any contacting portions between parts in relative rotation. Friction is reduced but the sealing function has to be optimized in particular against heavy pollution, in particular jets and/or sprays of water.

### SUMMARY

The aim of the disclosure is to provide a suspension thrust bearing unit with an improved labyrinth seal having optimized sealing performance while limiting rotational friction which is also easy and economical to manufacture.

To this end, the disclosure concerns a suspension thrust bearing unit for use in an automotive suspension assembly. The suspension thrust bearing unit comprises a bearing with an upper ring mounted inside an upper annular cap, a lower ring mounted inside a lower annular cap, and at least one row of rolling elements positioned between raceways defined by the lower and upper rings. The lower and upper annular caps are provided with sealing means to prevent entry of pollution into the interior of the unit where the bearing is located.

The lower annular cap comprises at least one annular circumferential groove provided between a first seal flange and a second seal flange that radially outwardly extend from the lower cap. The upper annular cap comprises an annular outer skirt that extends axially from the upper cap towards the lower cap, at least one of the seal flanges of lower cap being radially surrounded by the skirt. The groove, flanges and skirt form a sinuous chamber defining labyrinth sealing means.

According to the disclosure, the annular circumferential groove is provided with a plurality of ribs. The ribs are circumferentially spaced within the groove. The ribs extend radially outwardly from the lower cap, are axially delimited between the first and second seal flanges, and are at least partly radially surrounded by the skirt.

By this arrangement, the interior of the suspension thrust bearing unit is sealed, i.e. protected from the entry of dust, particles, and water from the environment. The radial flanges form physical barriers to water jets coming substantially axially or obliquely from the bottom of vehicle towards the suspension thrust bearing unit. The use of a plurality of radial flanges enables the blockage of successive pollution entries that manage to bypass previous flanges. The axial skirt of the upper cap surrounds the flanges and ensures protection against radial projections of pollution. The labyrinth sealing means of the disclosure ensures improved watertightness in axial, radial and oblique directions. The arrangement of successive sealing means permits a reduction in the quantity of pollution that can pass each of the sealing means.

Further, the plurality of ribs enables movement of the pollution flowing into the labyrinth seal to be disrupted. More precisely, the ribs form axial walls that are circumferentially spaced within the groove, while the flanges form radial walls. Flanges prevent the pollution from entering the groove, and the ribs disrupt the pollution kinetics within the groove. The labyrinth seal efficiency is then strongly improved.

Sealing function is designed without any contacting element between the lower and upper caps in relative rotation so as to reduce friction.

The lower and upper rings of bearing define an internal space in which rolling elements are arranged. The lower and upper rings are mounted inside the lower and upper caps of unit, respectively, a sinuous chamber being defined between the caps. The sinuous chamber forms an extension from the internal space in bearing. Such an arrangement permits lubricant, such as lubricant grease material, to be added into the internal space after the unit is mounted.

According to further aspects of the disclosure which are advantageous but not compulsory, such a suspension thrust bearing unit may incorporate one or several of the following features: the inner and outer rings may be made from a stamped metal sheet; the upper and lower caps may be made from a rigid plastic material, for example polyamide, optionally reinforced with glass fibers; the upper and/or lower caps may comprise stiffening insert; the bearing may be a rolling bearing, the inner and outer rings may define an annular rolling chamber therebetween and at least one row of rolling elements may be disposed within the rolling chamber; and /or the rolling elements may be balls.

Furthermore, optionally, the lower annular cap may include a damping device dedicated to form a seat for a suspension spring; the lower annular part may include an axial hub and the first flange radially outwardly extends from the hub; the damping device may comprise a portion covering a lower radial surface of the first radial flange, the damping device being dedicated to form a seat for a suspension spring, the damping device may comprise a portion covering an outer cylindrical surface of the hub, the portion of damping device being dedicated to support radial load from a suspension spring, the damping device may comprise a radial flange that protrudes radially outwardly beyond the first flange of lower annular cap, and the damping device may be made from a resilient material, such as rubber, thermoplastic elastomer (TPE), in particular thermoplastic polyurethane (TPU), melt processible elastomer (MPE) or cellular polyurethane.

In addition, optionally, the first seal flange may extend radially beyond the second seal flange of lower annular cap; the axial skirt of upper annular cap may radially surround the second seal flange of lower annular cap and be axially directed towards the first flange of lower annular cap, the lower cap may comprise a plurality of annular circumferential grooves, each being defined between upper and lower seal flanges; and the lower annular cap may comprise a third flange that extends radially outwardly from the cap, an annular circumferential groove being defined between second and third seal flanges, and the third flange being surrounded by the axial skirt of upper annular cap.

Furthermore, optionally, the second seal flange may extend radially beyond the third seal flange of lower annular cap. Each of the annular circumferential grooves may be provided with circumferentially spaced ribs, the ribs extending radially outwardly from the lower cap and being axially delimited between the seal flanges that define the corresponding outer circumferential groove, and being at least partly radially surrounded by the skirt. The upper annular cap may comprise a second axial skirt that extend axially from the cap towards the second flange of lower annular cap, the second axial skirt radially surrounding the third flange of lower annular cap, the second axial skirt being radially surrounded by first axial skirt of upper annular cap. The ribs may be circumferentially equally spaced, and ribs of the different annular circumferential grooves may be aligned circumferentially each other.

### BRIEF DESCRIPTION OF THE DRAWINGS

The disclosure will now be explained in connection with the annexed figures, as an illustrative example, without restricting the disclosure.

FIG. 1 is a top plan view of a top of a suspension thrust bearing unit according to an embodiment of the present disclosure.

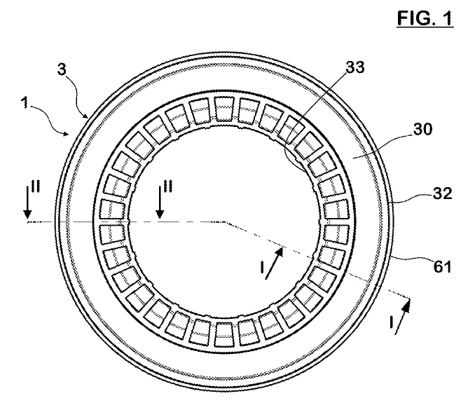

FIG. 2 is a perspective view of a lower cap of the suspension thrust bearing unit of FIG. 1.

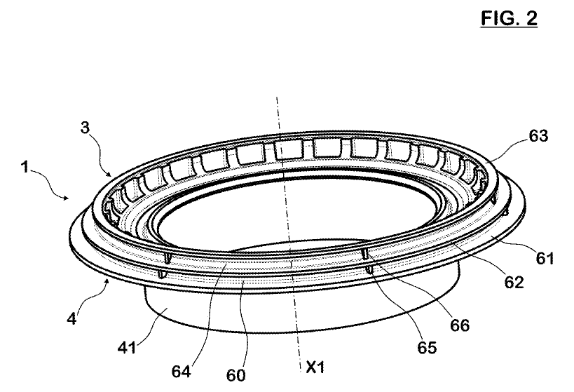

FIG. 3 is a first sectional view through one location of the suspension thrust bearing unit of FIG. 2.

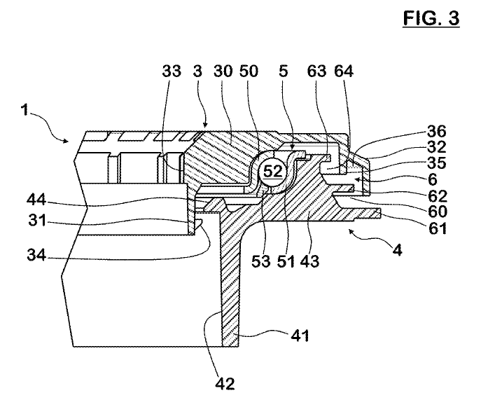

FIG. 4 is a second sectional view through a second location of the suspension thrust bearing unit of FIG. 2.

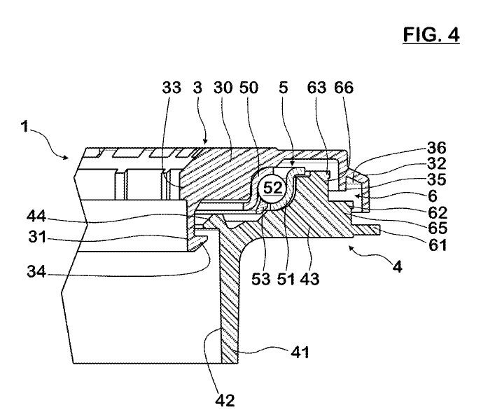

### DETAILED DESCRIPTION

A suspension thrust bearing unit 1 with central axis X1 is mounted between a helical suspension spring (not shown) and a support block (not shown) connected to the chassis of a motor vehicle. Such suspension a thrust bearing unit 1 can be used, for example, in an automotive MacPherson strut assembly.

Hereinafter, the adjectives “axial” and “radial” are defined relative to the central axis X1 of the annular thrust bearing 1.

The suspension thrust bearing unit 1 comprises an upper cap 3, a lower cap 4 and a single rolling bearing 5. These three components 3, 4 and 5 are of globally circular shape about central axis X1.

The upper cap 3 is a one-piece part made from plastic synthetic material, for example from polyamide, optionally reinforced with glass fibers. The upper cap 3 has an upper radial portion 30, an inner annular skirt 31 of relatively small diameter that extends towards the lower side of the suspension thrust bearing unit 1, and an outer annular skirt 32 of relatively large diameter that extends towards the lower side of the suspension thrust bearing unit 1. The upper cap 3 is configured to be fixed to a support block (not shown) of the automotive vehicle chassis.

The rolling bearing 5 comprises a pressed sheet metal inner race 50, an outer race 51 also of pressed sheet metal, a row of rolling elements 52, here balls, and a cage 53 for maintaining a regular circumferential spacing between the rolling elements 52. The rolling elements 52 are disposed between raceways formed by toroidal portions of the inner race 50 and the outer race 51. As an alternative not shown, the rolling elements may be rollers.

The rolling bearing 5 is integrally radially located between the inner skirt 31 and the outer skirt 32 of the upper cap 3. The inner race 50 is fitted within a toroidal inner portion of the upper cap 3. The outer race 51 is fitted onto a toroidal outer portion of the lower cap 4.

The lower cap 4 comprises a hub 41 defining an inner bore 42. The inner skirt 31 defines an inner bore 33 for the suspension thrust bearing unit 1, an elongate shock absorber rod (not shown) being mounted in bores 33, 42. The inner skirt 31 of upper cap 3 comprises a plurality of outwardly projecting clips 34 directed towards the hub 41 of lower cap 4. The lower cap comprises an inwardly projected clip 44 directed towards the skirt 31. The clips 34 are extended on a restricted angle, while the clip 44 is annular. Clips 34, 44 cooperate to ensure axial assembly of upper and lower caps 3, 4. Clips 34 and 44 each comprise a frustoconical surface to facilitate the assembly of the caps 3, 4.

The lower cap 4 further comprises an outwardly projecting radial flange 43 that extends from the hub 41 towards the exterior of the suspension thrust bearing unit 1. The toroidal outer portion supporting the outer race 51 of the rolling bearing 51 is provided on an upper surface of the radial flange 43. The hub 41 of lower cap 4 supports radial load and shocks from the suspension spring, and also permits to damp vibrations.

The lower cap 4 and the upper cap 3 further comprises a sealing assembly (sealing means) 6 to prevent the entry of pollution within the internal space defined between the caps 3, 4 and between rings 50, 51 of bearing 5. According to the disclosure, the sealing means 6 is a labyrinth seal designed as follows.

The lower annular cap 4 comprises a first annular circumferential groove 60 provided between a first seal flange 61 and a second seal flange 62 that extend radially outwardly from the lower cap 4. More precisely, the seal flanges 61, 62 are annular according to a parallel radial extension. The first seal flange 61 is a radial outer extension of the radial flange 43 of the lower cap 4. The second seal flange 62 is axially shifted from the first seal flange 61 towards the upper cap 3, thus defining the outer circumferential groove 60. Advantageously, the first flange 61 radially extends beyond the second flange 62 of lower annular cap 4.

The upper annular cap 3 comprises the annular outer skirt 32 that extends axially from the upper cap 3 towards the lower cap 4. The second flanges 62 of the lower cap 4 are radially surrounded by the skirt 32. In the present embodiment, the skirt 32 is directed towards the cap flange 43, the end of the skirt 32 radially faces the first seal flange 61 and axially faces the second seal flange 62. The groove 60, the flanges 61 and 62, and the skirt 32 form a sinuous chamber defining labyrinth sealing means 6. As an alternate not shown, the skirt 32 may radially surround the first flange 61.

The radial first seal flange 61 forms a first axial stop for pollution, in particular for blocking axial and oblique water or dust jets. The second flange 62 forms a second axial stop for pollution, in particular for blocking residual pollution not blocked by the first flange 61. The groove 60 directs residual pollution from the second to the first flange. The skirt 32 forms a radial stop for pollution. The skirt 32 also permits pollution that is blocked by second flange 62 to be directed to the outside of the unit 1. Gaps between the first flange 61 and the skirt 32, and between the second flange 62 and the skirt 71, are reduced so as to limit the entry dimension between the lower and the upper caps for pollution but without any contact. Rotational friction is prevented between caps 3, 4 in relative rotation by bearing 5.

Advantageously, the lower annular cap 4 comprises a third seal flange 63 that extends radially outwardly from the cap 4. The third seal flange 63 is annular according to a radial extension parallel to the first and second flanges 61, 62. The third seal flange 63 is axially shifted from the second seal flange 62 towards the upper cap 3, thus defining a second outer circumferential groove 64. The third flange 63 is surrounded by the axial skirt 32 of upper annular cap 3. Advantageously, the second flange 62 extends radially beyond the third flange 63 of the lower annular cap 4.

Advantageously, the upper annular cap 3 comprises a second axial skirt 35 that extends axially from the cap 3 towards the second flange 62 of the lower annular cap 4. The second axial skirt 35 radially surrounds the third flange 63 of the lower annular cap 4, and the second axial skirt 35 is radially surrounded by the first axial skirt 31 of the upper annular cap 3. An annular groove 36 is defined between the first and second skirts 31, 35 in the annular cap 3.

The radial third seal flange 63 forms a third axial stop for pollution, in particular for blocking residual pollution not blocked by the first and second seal flanges 61, 62. The groove 64 directs residual pollution from the second flange to the third flange. The skirt 35 permits pollution that is blocked by third flange 63 to be directed toward the outside of unit 1. The groove 36 blocks redirected pollution that passes the second flange 72. Gaps between the second flange 62 and the skirt 35, and between the third flange 63 and the skirt 35, are reduced so as to further limit the entry dimension between the lower and the upper caps for pollution but without any contact. This design forms a multi-level labyrinth seal for the unit.

According to the disclosure, the first and second annular circumferential grooves 60, 64 are both provided with a plurality of ribs 65, 66, respectively. The first annular circumferential groove 60 is provided with a first series of ribs 65. The ribs 65 are circumferentially equally spaced within the groove 60. The ribs 65 extend radially outwardly from the lower cap 4, and are axially delimited between the first seal flange 61 and the second seal flange 62.

The second annular circumferential groove 64 is provided with a second series of ribs 66. The ribs 66 are circumferentially equally spaced within the groove 64. The ribs 66 extend radially outwardly from the lower cap 4, and are axially delimited between the second seal flange 62 and the third seal flange 63.

In the illustrated example, the ribs 65, 66 of the different annular circumferential grooves 60, 64 are aligned circumferentially with each other.

As an alternate embodiment, only one of the two grooves 60, 64 is provided with a series of ribs. According to another embodiment, the lower cap 4 may comprise more than two annular circumferential outer grooves, each of them being provided with a series of ribs.

The plurality of ribs 65, 66 disrupts the pollution flowing into the labyrinth seal 6. More precisely, the ribs 65, 66 form axial walls that are circumferentially spaced within the grooves 60, 64, while the seal flanges 61, 62, 63 form radial walls. The flanges 61, 62, 63 prevent the pollution from entering the grooves 60, 64, and the ribs 65, 66 disrupt the pollution kinetics within the grooves 60, 64. The efficiency of the labyrinth seal 6 is then strongly improved.

According to an alternate not shown, the lower cap 4 may comprise a damping device made from a resilient material, such as rubber, thermoplastic elastomer (TPE), in particular thermoplastic polyurethane (TPU), melt processible elastomer (MPE) or cellular polyurethane for example. The damping device may be provided to the lower side of the lower cap 4, so as to support and damp the spring.

Representative, non-limiting examples of the present disclosure were described above in details with reference to the attached drawings. This detailed description is merely intended to teach a person of skill in the art further details for practicing preferred aspects of the present teachings and is not intended to limit the scope of the disclosure. Furthermore, each of the additional features and teachings disclosed above may be utilized separately or in conjunction with other features and teachings to provided improved suspension thrust bearing unit.

Moreover, various features of the above-described representative examples, as well as the various independent and dependent claims below, may be combined in ways that are not specifically and explicitly enumerated in order to provide additional useful embodiments of the present teachings.

What is claimed is:

1. A suspension thrust bearing unit for use in an automotive suspension assembly, comprising:
an upper annular cap,
a lower annular cap, and
a bearing comprising an upper ring mounted in the upper annular cap and a lower ring mounted in the lower annular cap and at least one row of rolling elements between a raceway of the upper ring and a raceway of the lower ring,
wherein the lower annular cap includes a first annular circumferential groove between a first radially outwardly extending seal flange and a second radially outwardly extending seal flange,
wherein the upper annular cap includes an outer axial skirt that extends axially from the upper cap towards the lower cap,
wherein the outer axial skirt radially surrounds the second radially outwardly extending seal flange,
wherein the first radially outwardly extending seal flange and the second radially outwardly extending seal flange and the outer axial skirt form a labyrinth seal,
wherein the first annular circumferential groove includes a plurality of circumferentially spaced ribs each extending radially outward from the lower cap and axially from the first radially outwardly extending seal flange to the second radially outwardly extending seal flange, and
wherein the plurality of ribs are at least partially located inside the outer axial skirt.

2. The suspension thrust bearing unit according to the claim 1,
wherein the ribs are equally circumferentially spaced.

3. The suspension thrust bearing unit according to the claim 1,
wherein the first radially outwardly extending seal flange extends radially beyond the second radially outwardly extending seal flange of the lower annular cap.

4. The suspension thrust bearing unit according to the claim 1,
wherein a distal end of the outer axial skirt faces the first radially outwardly extending seal flange.

5. The suspension thrust bearing unit according to the claim 1,
wherein the lower annular cap includes a third radially outwardly extending seal flange,
wherein a second annular circumferential groove is located between second radially outwardly extending seal flange and the third radially outwardly extending seal flange,
wherein the second radially outwardly extending seal flange is located between the first radially outwardly extending seal flange and the third radially outwardly extending seal flange, and
wherein the third radially outwardly extending seal flange is located inside the outer axial skirt.

6. The suspension thrust bearing unit according to the claim 5,
wherein the second radially outwardly extending seal flange extends radially beyond the third radially outwardly extending seal flange.

7. The suspension thrust bearing unit according to the claim 6,
wherein the upper annular cap includes an inner axial skirt that extends axially from the cap towards the second radially outwardly extending seal flange,
wherein the inner axial skirt radially surrounds the third radially outwardly extending seal flange, and
wherein the inner axial skirt is located radially inward of the outer axial skirt.

8. The suspension thrust bearing according to claim 7,
wherein a distal end of the inner axial skirt is located axially between the third radially outwardly extending seal flange and the second radially outwardly extending seal flange, and
wherein a distal end of the outer axial skirt is located axially between the second radially outwardly extending seal flange and the first radially outwardly extending seal flange.

9. The suspension thrust bearing according to claim 8,
wherein the first radially outwardly extending seal flange extends radially beyond the outer axial skirt.
